(19) United States
(12) Patent Application Publication
(10) Pub. No.: US 2007/0066727 A1
(43) Pub. Date: Mar. 22, 2007

(54) Hydrolysis stabilizer formulations

(75) Inventors: Steffen Denzinger, Mainz (DE); Frank Lammerzahl, Heidelberg (DE); Harald Zimmer, Morstadt (DE); Alexander Schmitt, Rodersheim-Gronau (DE)

Correspondence Address: FOLEY AND LARDNER LLP;SUITE 500, 3000 K STREET NW, WASHINGTON, DC, 20007, US

(73) Assignee: RASCHIG GmbH

(21) Appl. No.: 11/524,537

(22) Filed: Sep. 21, 2006

(30) Foreign Application Priority Data
Sep. 21, 2005 (DE) 10 2005 045 068.7

(51) Int. Cl. C08K 5/29

(52) U.S. Cl. 524/195

(57) ABSTRACT

This invention relates to extruded particles from a mixture of monomeric and polymeric carbodiimides and to a method for the stabilization of polymers, in particular polyesters, with the extruded particles.

### CROSS-REFERENCE TO RELATED PATENT APPLICATIONS

The right of foreign priority is claimed under 35 U.S.C. § 119(a) based on Federal Republic of Germany Application No. 10 2005 045 068.7, filed Sep. 21, 2005, the entire contents of which, including the specification, drawings, claims and abstract, are incorporated herein by reference.

### BACKGROUND OF THE INVENTION

The present invention relates to formulations for plastic additives, in particular hydrolysis stabilizers, and to plastic compositions stabilized thereby. The invention also relates to a method for stabilizing plastic compositions that are subject to hydrolysis. This invention relates to extruded particles made up of a mixture of hydrolysis stabilizers.

It is known to use aliphatic, aromatic or cycloaliphatic mono-, bis- or polycarbodiimides for the stabilization of plastics, especially those based on polyester. Reference is here made, by way of example, to the following patents and patent applications: EP 503 421 B1; CH 621 135; U.S. Pat. No. 3,193,522; EP 473 633; DE 1 285 747; and EP 567 884.

Until now, these substances were used either as a powder or, respectively, a melt or as so-called master batches. Powders or melts cause difficulties with dosing and distribution in the polymer. Master batches refer to concentrated master preparations of a substance mixed together with the polymer for which the substance is to be used. With regard to dosing and distribution, master batches are optimal since they are available in the same granulate form and size as the polymer. However, it is recognized that master batches should be produced with the same polymer as that which will be eventually stabilized. This means, on the one hand, that a unique preparation for each individual case will thus be required. On the other hand, the utilization of a master batch, the polymer material which is used for the production of the master batch will become exposed to higher temperatures for a longer period of time. Due to this thermal stress, early decomposition will take place, which is most clearly evident in a discoloration of the granulate of the master batch.

For overcoming the mentioned problems, JP 2004-124010 proposes pressing the hydrolysis stabilizer together with a thermoplastic polymer to form pellets. However, these pellets contain, on the one hand, a polymer just like the master batch and, on the other hand, they comprise—like powders or melts—a different spatial structure than the polymer granulate into which they are to be incorporated. Thus, they also exhibit the inherent problems of distribution in the polymer.

Accordingly, there is a continuing need for a suitable formulation for carbodiimide stabilizers.

### SUMMARY OF THE INVENTION

In accordance with one aspect of the present invention, a stabilizer composition is provided consisting essentially of extruded particles of at least one non-polymeric, preferably monomeric, carbodiimide, with at least one polymeric carbodiimide, and optionally other plastic additives. The particles according to the invention are preferably free or substantially free of thermoplastic polymer materials or other bonding agents.

In accordance with another aspect of the invention, there is provided a method for stabilizing a polymer composition, comprising mixing with the polymer composition a stabilizer composition comprising extruded particles of a mixture of at least one non-polymeric carbodiimide with at least one polymeric carbodiimide. Stabilized polymer compositions are also provided.

Further objects, features and advantages of the present invention will become apparent from the detailed description of preferred embodiments that follows, when considered together with the accompanying figures of drawing.

### BRIEF DESCRIPTION OF THE DRAWINGS

In the drawings:

FIG. 1 shows the distribution of a formulation of the prior art in a polyester after shaking for 10 min;

FIG. 2 is an enlarged view of FIG. 1;

FIG. 3 shows the distribution of a formulation according to the invention in a polyester after shaking for 10 min; and

FIG. 4 is an enlarged view of FIG. 3.

### DETAILED DESCRIPTION OF THE PREFERRED EMBODIMENTS

Surprisingly, it has now been found that mixtures of biscarbodiimides and polymer carbodiimides can be extruded to form granulates, which is not possible with the individual substances.

A preferred embodiment comprises only a mixture of carbodiimide and polymeric carbodiimide.

In another preferred embodiment, additional additives are added, such as, e.g., antioxidants, light and UV stabilizers, matting agents, additives for the improvement of colorability or for the reduction of electrostatic charges, flame retardants, as well as organic or inorganic dyes or mixtures of two or more of the stated additives. Especially preferred are formulations containing antioxidants and/or light or, respectively, UV stabilizers, in addition to the monomeric and polymeric carbodiimides.

With the formulations according to the invention, excellent homogenization in the polymer is possible. Here, the granulated stabilizer can be permanently homogeneously distributed in solid form in the polymer granulate without any thermal stress occurring. The dwell time of the polymer in the extruder until homogenization of the stabilizer is much shorter. With the same dwell time, better homogenization will be achieved; the stabilizer will be distributed better from the beginning and thus can also protect the entire mass from the beginning. With powders or even pellets, despite an initially homogeneous mixture of the solids, separation will occur already during the transport to the extruder. Thus, the stabilizer cannot protect uniformly enough, from the beginning, against thermal decomposition.

The particles according to the invention are suitable as stabilizers for plastics that contain hydrolysable groups, especially polymers based on polyester. This includes, inter alia, poly-condensation products such as polyesters, polyamides, polycaprolactones, polyesteramides, polyimides, polyamidimides, polyetherimides and polyether ester, as well as poly-addition products such as polyurethane, polyureas and polyurea/polyurethane elastomers, as well as radically produced polymers, such as, polyvinyl acetate, and natural polymers, such as cellulose, cellulose derivatives and starch.

The formulations according to the invention are especially suitable for use with aliphatic/aromatic polyesters, such as, e.g., polyethylene terephthalates or polybutylene terephthalates, but are also suitable for use with entirely aromatic and, for example, with halogenated polyesters. Components of polyesters are preferentially diols and dicarbonic acids or, respectively, correspondingly structured oxycarbonic acids. The main acid component of the polyesters is preferably terephthalic acid; suitable are, of course, other preferably para- or trans-position compounds such as, e.g., 2,6-naphthalene dicarbonic acid, and p-hydroxy benzoic acid. Moreover, aromatic m-position di-acids, such as, isophthalic acid, can be included as co-monomers in the polyester. Typically suitable bi-valent alcohols would be, for example, ethylene glycol, propandiol, 1,4-butandiol, and also hydroquinone and similar compounds. Preferred aliphatic diols have two to four C-atoms. Especially preferred is ethylene glycol.

The concentration of stabilizer in the polymer is preferably in a range from 0.05 to 5 % by weight, preferably 0.1 to 1.0 % by weight, and especially preferably 0.3 to 0.8% by weight.

The monomeric and polymeric carbodiimides used as stabilizers are known per se. They have the formula
R—[—N═C═N—]ₙ—N═C═N—R
wherein R means the same or different optionally substituted alkyl, cycloalkyl, or aryl groups, and n is 0 for the carbodiimide and ≧2, preferably 10 to 100, for the polycarbodiimdes. Especially preferred are monomeric and polymeric carbodiimides, with R being substituted aryl groups, particularly preferably aryl groups substituted by alkyl groups.

Accordingly, suitable as carbodiimides are the aryl-, alkyl- and cycloalkyl carbodiimides. The aryl nuclei can be unsubstituted; preferably, however, they are substituted in the 2- or in the 2,6-position, and thus sterically hindered carbodiimides are preferably used. Especially preferred are aromatic carbodiimides substituted with isopropyl groups.

According to the invention, suitable polycarbodiimide compounds are those in which the carbodiimide units are connected with each other via single, double or triple substituted aryl nuclei. Suitable aryl nuclei are phenylene, naphthalene, diphenylene and the bivalent residue derived from diphenyl methane. Substituents are selected according to the type and the place of substitution in accordance with the substituents of the biscarbodiimides substituted in the aryl nucleus. A particularly preferred polycarbodiimide is the commercially available aromatic polycarbodiimide which is substituted in the o-position of the carbodiimide groups, i.e., substituted with isopropyl groups in 2,6- or 2,4,6 position on the benzene nucleus. The polycarbodiimides preferably have a mean molecular weight (determined by means of GPC in tetrahydrofurane) from 2,000 to 25,000, more preferably from 5,000 to 15,000.

In the formulations according to the invention, the ratio of mono- and polycarbodiimide is preferably 5:95 to 95:5, more preferably 10:90 to 90:10 and especially preferably 40:60 to 60:40.

Additional additives may be, e.g., antioxidants, especially from the group of sterically hindered phenols, e.g. the Irganox types of Ciba Spezialitaitenchemie AG, or the Ralox types of Raschig GmbH; P-based thermal stabilizers, such as, e.g., the Irgafos types of Ciba Spezialitatenchemie AG; and light protection additives, especially stabilizers based on sterically hindered amines (HALS), such as, e.g., the Tinuvin types of Ciba Spezialitatenchemie AG.

Typical additives for polyamides are copper iodide systems as inorganic antioxidants and light stabilizers, sterically hindered phenols and phosphites as organic antioxidants and light stabilizers, and aromatic amines as antioxidants and light stabilizers.

Typical additives for polyesters are antioxidants, such as, Irganox 245 and Irganox 1010 of Ciba Spezialitatenchemie AG, light stabilizers such as Tinuvin 234, Tinuvin 1577 and Irgafos 168 of Ciba Spezialitätenchemie AG.

When one or several additional additives are included, their mass share is each from 1 to 60% by weight, preferably from 5 to 30% by weight.

The dimensions of the particles according to the invention are preferably selected to have size and configuration similar to those of the granulates of the polymer which is to be stabilized. This guarantees an efficient and homogeneous mixture with polymer materials and ensures that no separation will occur. Accordingly, the particles according to the invention are typically cylindrical granulates with a diameter in the range from 0.5 to 5 mm, preferably 1 to 2 mm, and a length ranging from 1 mm to 1 cm, preferably, 2 to 5 mm. Another typical form are ellipsoidal chips with a diameter of 3 mm to 1 cm, preferably 3 to 6 mm, and a length of 2 to 5 mm at the thickest point.

For production, the specified components are at first mechanically mixed as homogeneously as possible in powder form or, respectively, in liquid and powder form. Subsequently, the mixture is processed to particles or pellets, preferably via an extruder.

For this, the additives are preferably homogeneously mixed in a known powder mixture, e.g., a countercurrent powder mixer or a hand-scoop mixer. The powdery mixture is passed to a granulating device. This consists, for example, of a granulating cylinder comprising passage bores with a diameter of 1.5 to 5 mm, preferably 2 to 3 mm, and a counter-rotating cooled pressure cylinder. The addition of the mixed stabilizers is realized, e.g., by means of a feed hopper—located above the cylinders—through which the stabilizers pass by means of gravity into the area of the cylinders. The two cylinders are expediently somewhat inclined so that the granulates will be carried out of the granulating cylinder. On the inside of the granulating cylinder, a stationary knife can be provided by means of which the stabilizer granulates are taken off and thus cut to the desired length.

Processing is preferably performed such that the stabilizer mixture is supplied to the granulating device and there solidified under pressure. The resulting solidified mass is pressed as an extrusion through the passage bores of the granulating cylinder, where it is taken off the surface and thus transformed into an extruded granulate. Granulation preferably occurs at increased pressure and at temperatures of below 100° C. This will ensure that the stabilizers are not thermally stressed. After cooling, the finished granulates can be further processed as desired.

The following examples are intended to illustrate the invention without limiting it, however, to the concrete embodiments described. Unless otherwise provided, any % information refers to the weight.

### EXAMPLE 1

### Manufacture of Granulates According to the Invention

A mixture of stabilizer 7000 and stabilizer 9000 (monomeric and polymeric carbodiimide hydrolysis stabilizers of Raschig GmbH) is pressed between a tubular granulating cylinder comprising passage bores and a counter-rotating cooled pressure cylinder at temperatures between 20° C. and 80° C. Depending on the mixing percentages, a pressure between 2 and 5 MPa will result. No additional pressure is applied. The passage bores are selected such that granulates of a diameter from 2 to 3 mm are produced. For the granulates, the color value b* according to DIN 5033 is measured by means of a spectral photometer CM-3600d from Minolta. The color value provides an indication for the quality of the stabilizer. One of the most important applications for polyester is the manufacture of fibers for which it is especially important that the polymers show no discolorations. Discolorations are a typical sign of the decomposition of the polymers, resulting in fiber breakage in the worst case. Table 1 below provides an overview on the manufactured granulates and their color values.

TABLE 1

| | Percentage | Percentage | | | | |
|---|---|---|---|---|---|---|
| Granu- | Stabilizer | Stabilizer | Temperature | Pressure | Diameter | |
| late | 7000 [%] | 9000 [%] | [° C.] | [MPa] | [mm] | b* |
| A | 10 | 90 | 40 | 4.8 | 3 | 5.4 |
| B | 30 | 70 | 75 | 4.2 | 3 | 5.2 |
| C | 50 | 50 | 60 | 4.2 | 2 | 5.2 |
| D | 68 | 32 | 35 | 3.8 | 2 | 5.0 |
| E | 90 | 10 | 25 | 3.7 | 3 | 4.7 |

### EXAMPLE 2

### Manufacture of Granulates with Additional Additives

Similarly to Example 1, granulates with the addition of further additives are manufactured at a temperature of 45° C. Table 2 provides an overview of the granulates obtained.

TABLE 2

| | Percentage | Percentage | | | |
|---|---|---|---|---|---|
| Gran- | Stabilizer | Stabilizer | | Diameter | |
| ulate | 7000 [%] | 9000 [%] | Additional additive [%] | [mm] | b* |
| F | 10 | 80 | Irganox 1010 (Ciba) | 3 | 5.0 |
| | | | 10% | | |
| G | 25 | 60 | Irgafos 168 (Ciba) 15% | 3 | 5.8 |
| H | 40 | 35 | Tinuvin 234 (Ciba) 25% | 2 | 5.4 |
| I | 63 | 32 | Ionol 220 (Degussa) 5% | 2 | 6.1 |

### EXAMPLE 3 (COMPARISON)

### Manufacture of Master Batches

A mixture of 1 to 15% of a polymer carbodiimide (Stabilisator 9000, Raschig GmbH) and a solids-condensed, non-matted polyester is extruded in a twin screw extruder ZK25 with a strand pelletizer, type CSG 171/1 of Dr. Collin GmbH, at an extruder temperature of 280° and a screw speed of 240 revs/min, to produce the master batches J-R.

A mixture of 5 to 10% of a polymer carbodiimide (Stabilisator 9000 of Raschig GmbH) and a polyamide is extruded in a twin screw extruder ZSK 40 with a strand pelletizer of Theyson at an extruder temperature of 260° C. and a screw speed of 240 revs/min, to produce the master batches S and T.

A mixture of 5 to 15% of a polymer carbodiimide (Stabilisator 9000 of Raschig GmbH) and a thermoplastic polyurethane is extruded in a twin screw extruded ZK 25 with a strand pelletizer, type CSG 171/1 of Dr. Collin GmbH, at an extruder temperature of 200° C. and a screw speed of 100 revs/min, to produce the master batches U and V.

Table 3 provides an overview of the manufactured master batch granulates and their color values b*.

TABLE 3

| | Percentage | | |
|---|---|---|---|
| | Stabilizer | | |
| Granulate | 9000 [%] | Type of polymer | b* |
| J | 15 | Polyester T86 (Invista Fibers & Resins | 12.1 |
| | | GmbH) | |
| K | 10 | Polyester T86 | 11.4 |
| L | 5 | Polyester T86 | 11.1 |
| M | 12 | Polyester T94 (Invista Fibers & Resins | 11.4 |
| | | GmbH) | |
| N | 1 | Polyester Polyclear 1101 (Invista Resins & | 9.4 |
| | | Fibers GmbH) | |
| O | 15 | Polyester Polyclear 1101 | 10.8 |
| P | 8 | Polyester Voridian CM01 (Eastman | 11.1 |
| | | Chemicals) | |
| Q | 15 | Polyester Lighter C98 (Equipolymers) | 13.6 |
| R | 12 | Polyester PBT, type 2000 (Invista Resins | 12.4 |
| | | & Fibers GmbH) | |
| S | 5 | Polyamide PA6, Ultramid B36 (BASF | 10.6 |
| | | AG) | |
| T | 10 | Polyamide PA6, Ultramid B36 (BASF | 15.2 |
| | | AG) | |
| U | 5 | TPU Elastollan 685A (BASF AG) | 10.3 |
| V | 15 | TPU Elastollan 685A (BASF AG) | 12.4 |

It is apparent that the color values of the master batch granulates are already significantly higher than with the granulates according to the invention.

### EXAMPLE 4

### Manufacture of Polyester Fibers

To evaluate the stabilizer granulates, fibers are drawn from a mixture of the polyester T86 (Invista) and the granulate from Example A or, respectively, the master batch from Example J (Comparison). Dosing of the additive components is adjusted such that 0.8% polycarbodiimide will be present in the end product. The additive components are continuously gravimetrically homogeneously mixed to the polyester at the inlet of the extruder. Table 4 provides an overview of the products and their color values.

| | | | Quantity of additive | |
|---|---|---|---|---|
| Product | Polymer | Additive | [%] | b* |
| W | T86 | Granulate A | 0.88 | 4.4 |
| X | T86 | Master batch J | 5.33 | 5.3 |

It is apparent that the use of the additive granulate according to the invention provides a product with a more advantageous yellow value.

### EXAMPLE 5

### Comparison of Particles According to the Invention with Pellets

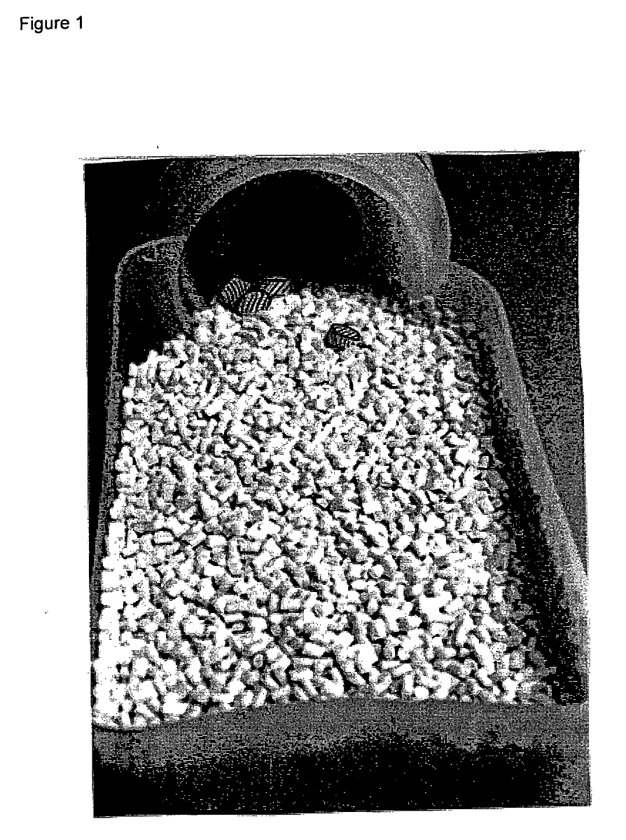

Two 1-liter volume wide-necked polyethylene bottles were each filled with 400 g polyethylene terephthalate granulate (RT 12, Invista Resins & Fibers GmbH). To one bottle, 7 pellets with a diameter of 8 mm and a height of 4 mm are added, corresponding to 2.3 g pressed polycarbodiimide. To the second bottle, 2.3 g granulate according to Example 1, No. A are added. The applied quantity of 2.3 g for 400 g is in accordance with 0.5% stabilizer percentage in polyethylene terephthalate. The content of both bottles is homogenized. Subsequently, the bottles were shaken on a laboratory shaker for 10 min in a horizontal position and were then cut open without changing their position. FIGS. 1 to 4 show the result of this treatment.

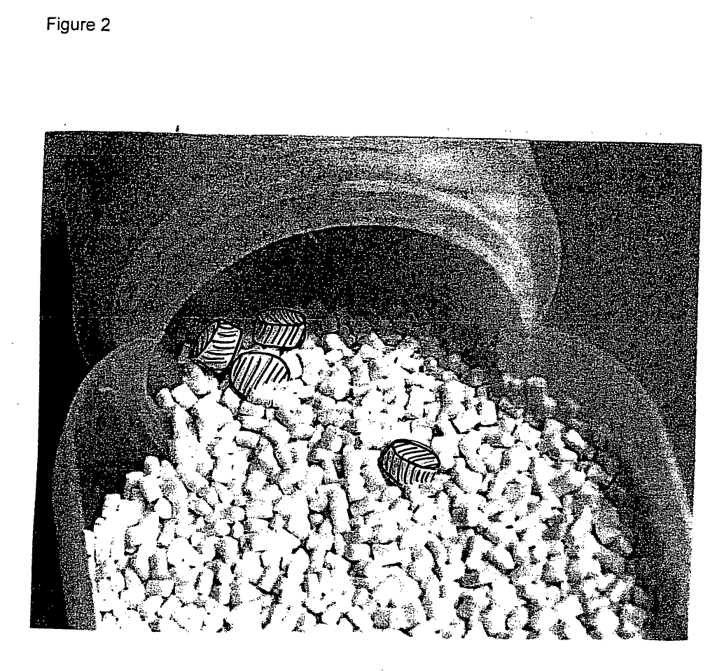

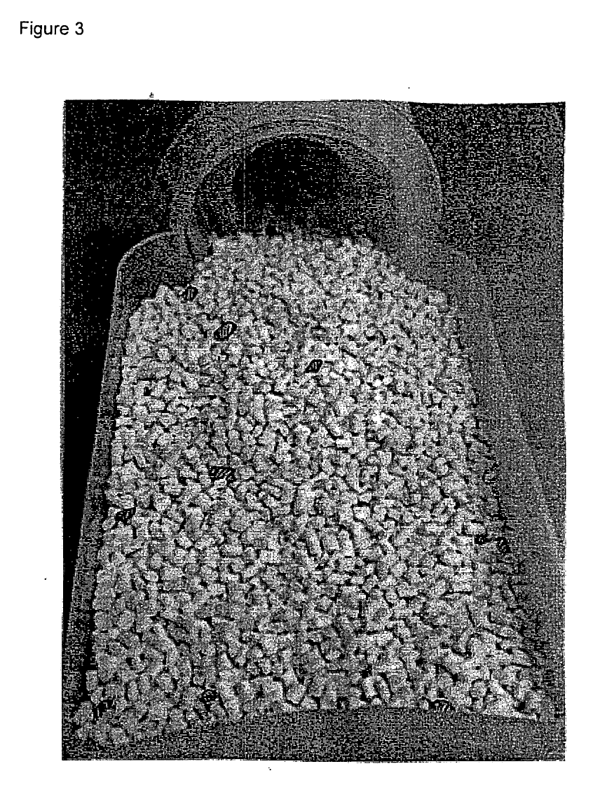

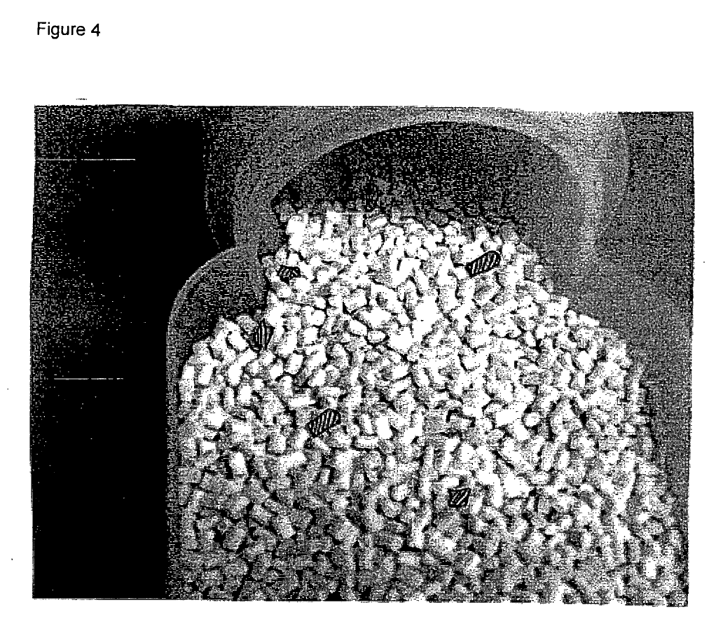

FIG. 1 and 2 clearly show that, of the 7 pellets in the first bottle, four collected on the bottleneck. Due to the shocks which reflect quite well the mechanical effects until melting in the extruder, more than half of the added stabilizer accordingly separated from the polyester. In contrast, no separation occurred in FIGS. 3 and 4, in which the particles according to the invention were stained to facilitate detection.

It is to be stated as a result that pellets are not homogeneously mixable as opposed to extruded particles. Pellets are more difficult to dose since pelleting is becoming more uneconomical and technically more elaborate with a decreasing size of the pellets. In contrast, the particles according to the invention can be exactly and homogeneously dosed via the customarily used shaker trough. Even a premix can be used since it can be easily manufactured by mechanical means and will be indefinitely stable.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A composition useful for the stabilization of a polymer, comprising extruded particles of a mixture of at least one non-polymeric carbodiimide with at least one polymeric carbodiimide.

2. A composition according to claim 1, wherein the non-polymeric carbodiimide comprises an aromatic carbodiimide substituted with an isopropyl group.

3. A composition according to claim 1, wherein the polymeric carbodiimide comprises a 2,6- or 2,4,6-isopropyl substituted aromatic polycarbodiimide having a mean molecular weight of 2,000 to 25,000 g/mol.

4. A composition according to claim 1, wherein the ratio of non-polymeric carbodiimide to polymeric carbodiimide is from 5:95 to 95:5.

5. A composition according to claim 1, further comprising at least one plastic additive selected from the group consisting of an antioxidant, a UV stabilizer, a matting agent, an additive for improving stainability, an additive for reducing electrostatic charges, a flame retardant and an organic or inorganic dye.

6. A composition according to claim 1, wherein the particles have a form and dimension essentially similar to those of a polymer granulate which is to be stabilized.

7. A composition according to claim 6, wherein the particles comprise cylindrical granulates with a diameter ranging from 0.5 to 5 mm, and a length ranging from 1 mm to 1 cm.

8. A composition accorded to claim 6, wherein the particles comprise ellipsoidal chips with a diameter of 3 mm to 1 cm, and a length of 2 to 5 mm at the thickest point.

9. A composition useful for the stabilization of a polymer, comprising extruded particles of a mixture consisting essentially of at least one non-polymeric carbodiimide with at least one polymeric carbodiimide.

10. A composition according to claim 9, wherein the polymeric carbodiimide comprises a 2,6- or 2,4,6-isopropyl substituted aromatic polycarbodiimide having a mean molecular weight of 2,000 to 25,000 g/mol.

11. A composition according to claim 9, wherein the ratio of non-polymeric carbodiimide to polymeric carbodiimide is from 5:95 to 95:5.

12. A composition according to claim 9, wherein the particles have a form and dimension essentially similar to those of a polymer granulate which is to be stabilized.

13. A method for stabilizing a polymer composition, comprising mixing with the polymer composition a stabilizer composition comprising extruded particles of a mixture of at least one non-polymeric carbodiimide with at least one polymeric carbodiimide.

14. A method according to claim 13, wherein the mixing comprises adding the stabilizer composition to the polymer composition by means of a shaker trough directly before introduction of the polymer composition into an extruder.

15. A method according to claim 13, wherein the mixing comprises adding a premix of the stabilizer composition with the polymer composition to the polymer composition.

16. A method according to claim 13, wherein the polymer composition comprises a polymer selected from the group consisting of an aliphatic/aromatic polyester, a polyurethane, a polyamide and a polyamidimide

17. Method according to claim 16, wherein the polymer composition comprises polyethylene terephthalate or polybutylene terephthalate.

18. A method according to claim 13, wherein the mixing comprises adding the stabilizer composition to the polymer composition when the polymer composition is in the form of extruded pellets.

19. A method according to claim 18, wherein the particles have a form and dimension essentially similar to those of the pellets in a polymer composition which is to be stabilized.

20. A polymer composition that has been stabilized against hydrolysis by the addition of a stabilizer composition comprising extruded particles of a mixture of at least one non-polymeric carbodiimide with at least one polymeric carbodiimide.

21. A polymer composition according to claim 20, wherein the polymer composition contains the stabilizer composition in an amount of 0.05-5% by weight.
